(19) United States
(12) Patent Application Publication
(10) Pub. No.: US 2002/0005646 A1
(43) Pub. Date: Jan. 17, 2002

(54) Apparatus for releasing items within a confined space

(76) Inventors: George Nelson Bliss, Birmingham, MI (US); Anthony W. Accettura, Farmington Hills, MI (US)

Correspondence Address: KENYON & KENYON, ONE BROADWAY, NEW YORK, NY, 10004, US

(21) Appl. No.: 09/849,006

(22) Filed: May 4, 2001

Related U.S. Application Data
(63) Continuation-in-part of application No. 09/484,340, filed on Jan. 18, 2000, now Pat. No. 6,237,978.
(63) Continuation-in-part of application No. 09/008,685, filed on Jan. 16, 1998, now Pat. No. 6,056,341.

(51) Int. Cl. B66C 1/42

(52) U.S. Cl. 294/88

(57) ABSTRACT

An automated actuation device for releasing items within a confined space, particularly an automated pickup head and gripping plate assembly which is used to grip egg cartons or trays and place those egg cartons or trays in stacks in a shipping container or basket. The actuation device includes a pickup head which may be mounted on any known or conventional apparatus for moving and orienting the pickup head and gripping plates to grasp individual items such as, e.g., egg cartons or trays, and to transfer those items to, and insert those items within, a confined space such as, e.g., a shipping container or basket.

### CROSS-REFERENCE TO RELATED APPLICATIONS

This is a continuation-in-part of U.S. patent application Ser. No. 09/484,340, filed on Jan. 18, 2000, which is a continuation-in-part of U.S. patent application Ser. No. 09/008,685, filed on Jan. 16, 1998, now U.S. Pat. No. 6,056,341, each of which is incorporated herein in its entirety by reference thereto.

### FIELD OF THE INVENTION

The present invention relates to an automated actuation device for releasing items within a confined space. In particular, the present invention relates to an automated pickup head and gripping plate assembly which is used to grip egg cartons or trays and place those egg cartons or trays in stacks in a shipping container or basket.

### BACKGROUND INFORMATION

Eggs are often packaged and sold in rectangular cartons containing a dozen or a dozen-and-a-half eggs (e.g., two or three rows of six eggs), which egg cartons are manufactured of a lightweight material such as polystyrene or cardboard. Eggs are also often shipped or processed using a generally square egg tray containing two-and-a-half dozen eggs (e.g., five rows of six eggs), which egg trays are generally manufactured of a pulp material or plastic. During a process of grading eggs at an egg farm or an egg processing plant, eggs are generally segregated according to, inter alia, size and condition, and are thereafter packed into the above-described egg cartons or trays. Usually, the egg cartons or trays are then stacked within larger shipping containers or wire plastic baskets for later transportation to a retail outlet. Because eggs are a fragile commodity, and because the egg cartons or trays into which eggs are shipped or processed are not particularly strong, it is necessary for the egg cartons or trays stacked in a shipping container or basket to be fairly tightly packed. Tight packing of egg cartons or trays in a shipping container or basket ensures minimum movement of the eggs and egg cartons or trays within the shipping container or basket, thereby reducing the chance of egg breakage during transportation.

Tight packing of egg cartons or trays within a shipping container or basket is generally accomplished using a shipping container or basket having very little clearance between the inside walls of the shipping container or basket and the outside edges of egg cartons or trays stacked therein. This small clearance can make gentle packing of egg cartons or trays, particularly those egg cartons or trays in the bottom of the shipping container or basket, difficult. Careful hand packing of the shipping containers or baskets can ensure gentle packing of egg cartons or trays within a shipping container or basket. However, hand packing of shipping containers or baskets reduces the speed at which the shipping containers or baskets may be packed, increases labor costs, and can result in repetitive motion injuries to the individuals doing the packing. It is therefore desirable to automate the process of packing shipping containers or baskets with egg cartons or trays. The limited clearance between the outside edges of egg cartons or trays being packed and the inside walls of the shipping container or basket severely limits the amount of space available for an automatic packing device to operate, presenting limitations on the design and operation of any automated packing apparatus. In particular, the limited clearance confines the dimensions of the packing device, which must be capable of being inserted within the interior of the shipping container or basket so as to prevent the need to drop cartons or trays into the bottom of the shipping container or basket. Furthermore, the limited clearance also confines the movement of the gripping structure on the packing device because the gripping structure must open to release the egg cartons or trays in the limited clearance between the outside edges of the egg cartons or trays and the inside walls of the shipping container or basket.

### SUMMARY

The present invention is an actuation device which allows the automatic gripping of items such as, e.g., egg cartons or trays, and the insertion of those items into a confined space such as, e.g., a shipping container or basket. The actuation device includes a linkage system which allows an entire pickup head and gripping plate assembly to be inserted into a confined space and thereafter the gripping plates to be retracted from the gripped item. As few as one actuation device is needed to grip and release items using the device of the present invention. It should be appreciated that any appropriate number of actuation devices may be provided as necessary. The actuation device of the present invention therefore provides cost advantages over the prior art.

According to the present invention, the device includes a pickup head, at least one gripping plate, a linkage system and an actuation device. The linkage system is configured to connect the gripping plate to the pickup head so that the gripping plate is movable relative to the pickup head between an open position and a closed position and so that the gripping plate is movable relative to the pickup head in at least one degree of freedom when the gripping plate is in the open position and the closed position. The actuator device is configured to move the gripping plate between the open position and closed position. This arrangement permits the items to be inserted into and removed from a confined space having relatively little clearance between the items and the inner walls of the confined space, e.g., a shipping container or basket.

### BRIEF DESCRIPTION OF THE DRAWINGS

FIG. 1 is a side elevational view of a first example embodiment of an actuating device according to the present invention in an open position;

FIG. 2 is a side elevational view of the first example embodiment of the actuating device illustrated in FIG. 1 in a partially closed position;

FIG. 3 is a side elevational view of the first example embodiment of the actuating device illustrated in FIG. 1 in a fully closed position;

FIG. 4 is a side elevational view of the first example embodiment of the actuating device illustrated in FIG. 1 in a partially retracted position;

FIG. 5 is a perspective view of a pickup head and gripping arm of a second example embodiment of the actuating device according to the present invention;

FIG. 6 is a perspective view of the pickup head and gripping arm of a third example embodiment of the actuating device according to the present invention;

FIG. 7 is a side elevational view of the third example embodiment of the actuating device illustrated in a closed position;

FIG. 8 is a side elevational view of a fourth example embodiment of an actuating device according to the present invention in an open position;

FIG. 9 is a side elevational view of the fourth example embodiment of the actuating device illustrated in FIG. 8 in a closed position;

FIG. 10 is a side elevational view of the fourth example embodiment of the actuating device illustrated in FIGS. 8 and 9 in a partially open position;

FIG. 11 is a perspective view of the third example embodiment of the actuating device illustrated in FIGS. 6 and 7;

FIG. 12 is another perspective view of the second example embodiment of the actuating device illustrated in FIG. 5; and

FIG. 13 is a top perspective view of a fifth example embodiment of an actuating device according to the present invention.

### DETAILED DESCRIPTION

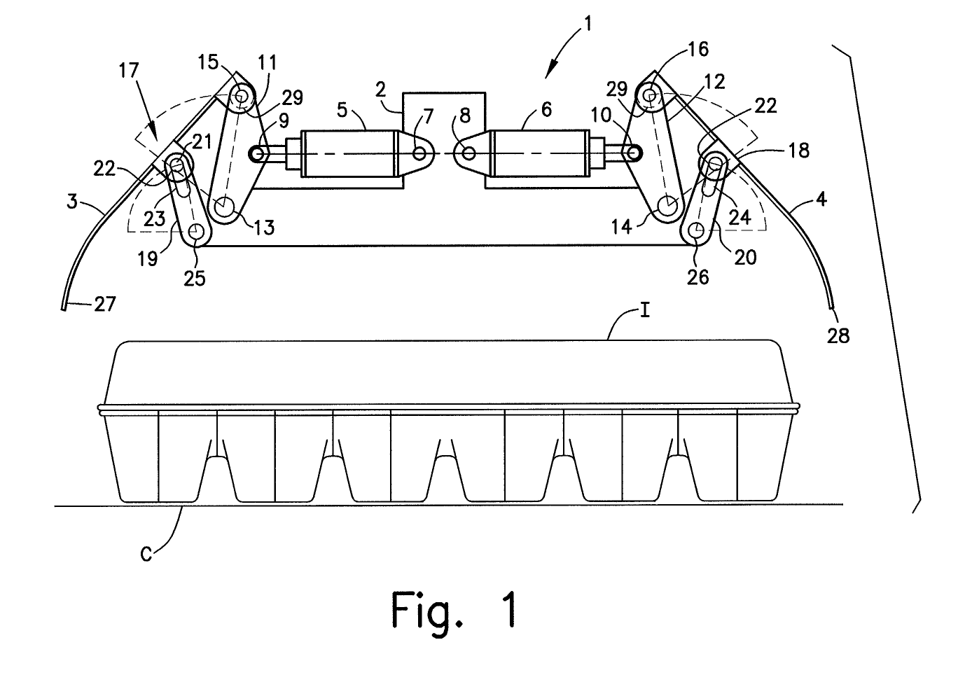

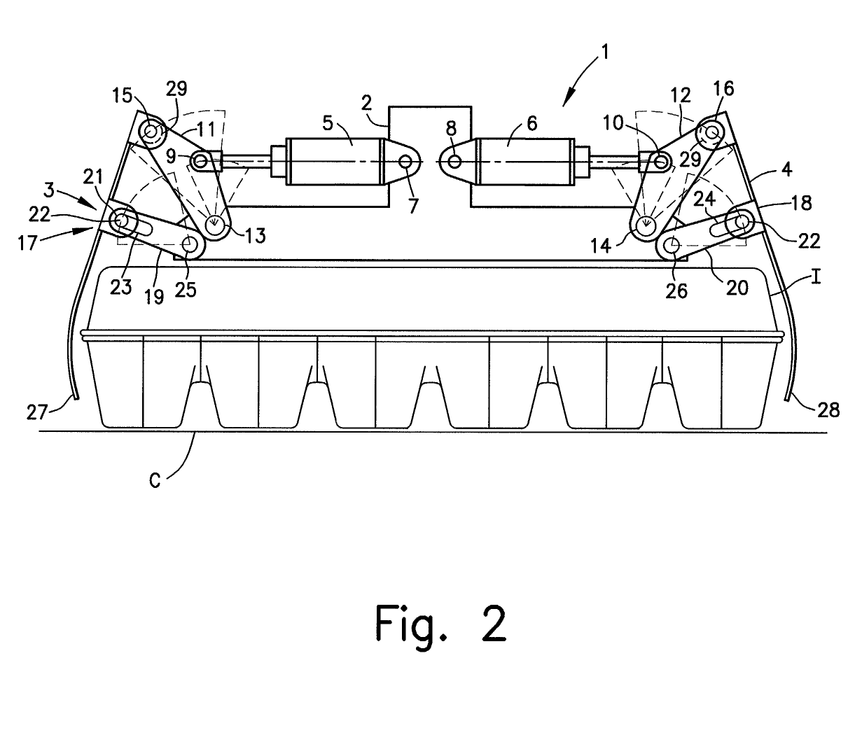

FIGS. 1 and 2 are side elevational views of a first embodiment of an actuation device according to the present invention. FIG. 1 illustrates the actuation device in an open position before an item I is gripped, and FIG. 2 illustrates the actuation device 1 in a partially closed position during the gripping of the item I. Actuation device 1 may be used to lift item I, which may be, for example, an egg carton or tray, from, for example, a conveyor C and to insert the item I into a confined space, such as, for example, the interior of a shipping container or basket. The actuation device 1 may include a pickup head 2, which may be connected to an automated device, not shown, for moving and orienting the pickup head 2 according to one or more degrees of freedom. The degrees of freedom may include vertical and horizontal movement and rotation about one or more axes.

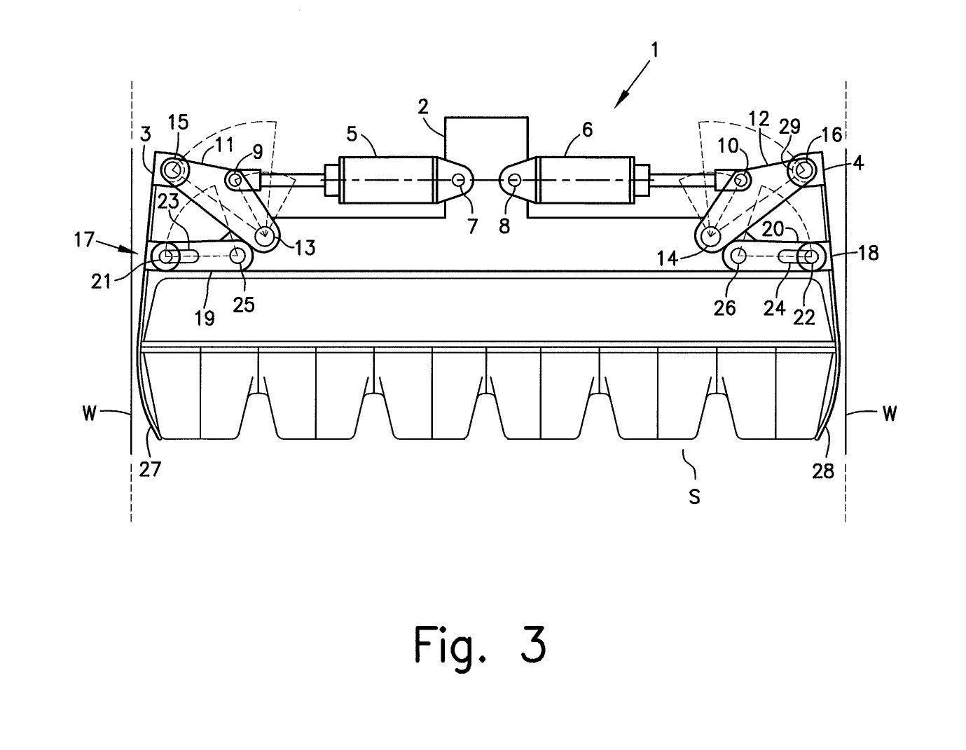

As illustrated in FIG. 1, the gripping plates 3, 4 of the device 1 are in an open position, prior to the lowering of the pickup head 2 toward the item I to be gripped and the closing of the gripping plates 3, 4 around the item I. In the open position, an actuation device, such as, e.g., two air cylinders 5, 6, is in its fully retracted position. In order to grip the item I, the pickup head 2 is lowered from the open position as illustrated in FIG. 1 to the partially closed position as illustrated in FIG. 2 and then to the fully closed position as illustrated in FIG. 3. In the partially closed position illustrated in FIG. 2, the pickup head 2 is lowered to be adjacent to the item I. Pickup head 2 may be lowered using the automated device, not shown, as described above to move the pickup head 2 vertically downwardly toward item I.

It should be appreciated that although the actuation device is illustrated in FIGS. 1 to 4 as two air cylinders 5, 6, the actuation device may be any known device configured to pivot links 11, 12 about pin connections 13, 14, such as, for example, one or more solenoids, linear motors, rotary motors, etc. In the first example embodiment of device 1 illustrated in FIGS. 1 to 4, the cylinders 5, 6 are pivotably mounted at one end to pickup head 2 via suitable pin connections 7, 8. The opposite ends of the cylinders 5, 6 are connected to first links 11, 12 via suitable pin connections 9, 10. First links 11, 12 are pivotably mounted at one end to pickup head 2 via suitable pin connections 13, 14 and at the other end to one end of gripping plates 3, 4 via suitable pin connections 15, 16. A biasing element 29 acts to normally bias gripping plates 3, 4 outwardly to a fully open position, as illustrated in FIGS. 1 and 2. The biasing element 29 may include, for example, a torsional spring acting against each of the first links 11, 12 and the corresponding end of gripping plates 3, 4. Intermediate portions 17, 18 of gripping plates 3, 4 are pivotably and slidably connected to a restraining device in the form of second links 19, 20. Pins 21, 22 are mounted on intermediate portions 17, 18 and are arranged to slide in slots 23, 24 disposed in one end of second links 19, 20. The pins 21, 22 are further arranged to permit relative rotation between second links 19, 20 and gripping plates 3, 4. The biasing devices 29 normally bias the gripping plates 3, 4 so that pins 21, 22 are urged to the outermost end of slots 23, 24 as illustrated in FIGS. 1 to 3. Second links 19, 20 are also pivotably mounted on pickup head 2 via suitable pin connections 25, 26.

Gripping plates 3, 4 may be constructed of a material, such as, for example, stainless steel, and may be formed relatively thin to allow the insertion thereof into and the removal thereof from the limited space between the outer peripheral edges of the item I to be gripped and the inner walls of the space in which the item I is inserted. A lower end 27, 28 of gripping plates 3, 4 may be slightly curved as illustrated in FIGS. 1 to 4. This slight curvature of the lower ends 27, 28 permits the lower ends 27, 28 to project under the item I to be gripped to thereby support the items I for lifting and insertion thereof. Gripping plates 3, 4 may be formed to have a width greater than the width of the item I to be gripped so that multiple items I may be gripped simultaneously. For example, the standard shipping container or basket for egg cartons or trays is sized to hold a stack of egg cartons or trays that is three dozen-egg cartons wide, two dozen-and-one-half-egg cartons wide and one two-and-one-half-dozen-egg trays wide. The width (the dimension into the sheet of FIGS. 1 to 4) of the gripping plates 3, 4 may consequently be equal to, or slightly less than, the width of three side-by-side dozen-egg cartons. Accordingly, the device 1 may grip three dozen-egg cartons, two dozen-and-one-half-egg cartons or one two-and-one-half-dozen egg tray during each gripping operation to thereby fill one entire layer of the shipping container or basket each time that the device 1 is inserted into the shipping container or basket. The pickup head 2 may be rotated by, for example, 90° for each layer of egg cartons or trays inserted into the shipping container or basket. This rotation of the egg cartons or trays tends to increase the stability of the stacked egg cartons or trays within the shipping container or basket.

Operation of the device 1 of the preferred embodiment of the present invention is as follows. A group of items I such as egg cartons or trays are conveyed down a conveyor C to a pickup location. The pickup head 2 is moved to a position above, and aligned with, the group of items I, as shown in FIG. 1. This movement is accomplished by any known or conventional apparatus (not shown) for horizontally, vertically, and rotationally moving the pickup head 2. If not accomplished already, a controller (not shown) for the device 1 operates to retract the cylinders 5, 6 to their fully retracted position (FIG. 1). In this fully retracted position, ends 27, 28 of gripping fingers 3, 4 are in their widest-apart position, and pins 21, 22 are biased by biasing devices 29 to the outward end of slots 23, 24. Thereafter, pickup head 2 is lowered to a position (FIG. 2) adjacent the group of items I to be gripped. The controller (not shown) thereafter activates the cylinders 5, 6 to their fully extended positions. Extension of cylinders 5, 6 causes first links 11, 12 to rotate outwardly around pin connections 13, 14. Outward rotation of first links 11, 12 results in downward movement of gripping fingers 3, 4, as well as inward movement of gripping finger ends 27, 28 as the result of the restraint imposed by second links 19, 20. In the fully extended position of cylinders 5, 6 (FIG. 3), curved ends 27, 28 of gripping fingers 3, 4 extend underneath items I to thereby support items I vertically and horizontally. In this position, pins 21, 22 continue to be biased by biasing devices 29 to the outward end of slots 23, 24.

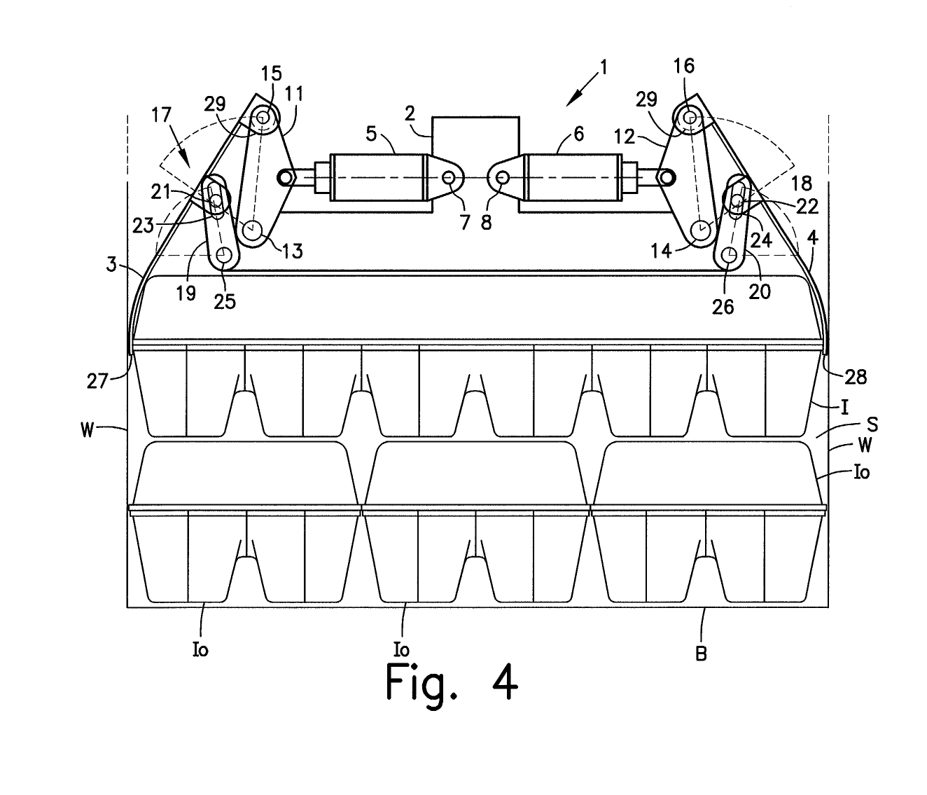

Pickup head is then moved to a position above the shipping container or basket to be filled, and on alternating layers is rotated by 90-degrees. The device 1 is centered over the space S to be filled, and the pickup head 2 is thereafter lowered using a conventional or known apparatus (not shown) for effecting vertical movement. Because the outside surfaces of the gripping fingers 3, 4 are the furthest lateral extent of the device 1, the device 1 can be lowered completely within the inside walls W of the shipping container or basket (FIGS. 3 and 4). The items I are lowered until they are placed on top of a previous layer of items Iₒ, or in the case of the first layer of items I, until they are placed on the bottom B of the shipping container or basket.

After the items I held by the device 1 are lowered to their desired position, the controller (not shown) controls the air cylinders 5, 6 to cause them to retract. Retraction of the air cylinders 5, 6 causes the first links 11, 12 to pivot inwardly, drawing the upper ends of gripping fingers 3, 4 upwardly and outwardly. Pins 21, 22 slide inwardly in slots 23, 24 as second links 19, 20 pivot inwardly, due to contact of ends 27, 28 with walls W. This contact, and the resulting force on the ends 27, 28, overcomes the bias of biasing elements 29, resulting in sliding movement of ends 27, 28 of gripping fingers 3, 4 along the outside edges of the items I (compare FIGS. 3 and 4). Outward movement of the gripping fingers 3, 4 during retraction is restrained by contact with walls W and compensated for by sliding of pins 21, 22 in slots 23, 24. The sliding motion of gripping fingers 3, 4 does not interfere with release of the items I within the shipping container or basket. After the air cylinder 5, 6 reach their fully retracted position (FIG. 4), the ends 27, 28 of gripping fingers 3, 4 are no longer under the items I, and the pickup head 2 may be lifted, while leaving the items I within the shipping container or basket. When the ends 27, 28 of gripping fingers 3, 4 clear the upper end of walls W during lifting of pickup head 2, the biasing force of biasing elements 29 cause the pins 21, 22 to snap outwardly in slots 23, 24, so that the device 1 assumes the position shown in FIG. 1.

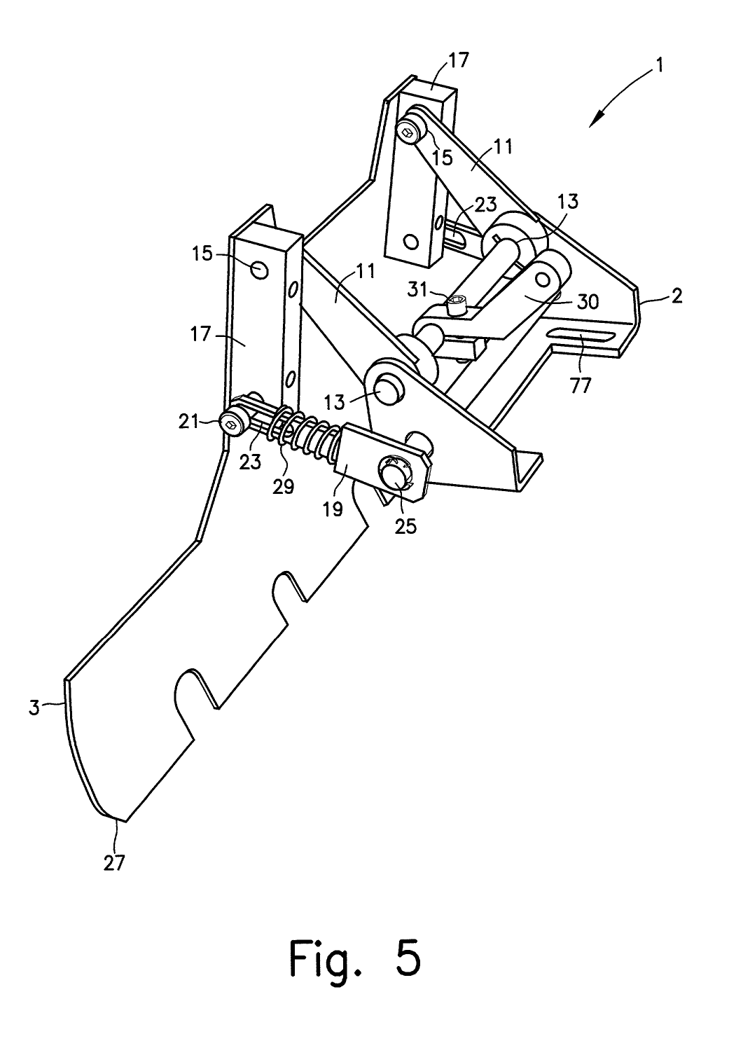

FIG. 5 illustrates a second example embodiment of the device 1 according to the present invention. In the second example embodiment of the device 1, the arrangement of the pickup head 2 is different from the arrangement of the pickup head 2 of the first example embodiment of the device 1 illustrated in FIGS. 1 to 4. More particularly, the pickup head 2 of the second example embodiment of the device 1 is connectable to a base plate 36 of the automated device, such as, for example, via a bolt, not shown, through bolt hole 77.

Moreover, the arrangement of the actuation device, i.e., the air cylinders 5, 6, in the second example embodiment of device 1 is different from the arrangement thereof in the first example embodiment of the device illustrated in FIGS. 1 to 4. Rather than being attached to the pickup head 2 or to the first links 11, 12, as arranged in the first example embodiment of device 1, the air cylinders 5, 6 of the second by example embodiment of device 1 are connected at one end to an actuating bar 30 and at the other end to a frame, not shown. The end of the actuating bar 30 opposite to the air cylinder 5, 6 is connected to pin connection 13 by, for example, a hooked end secured around the pin connection 13 via bolt 31.

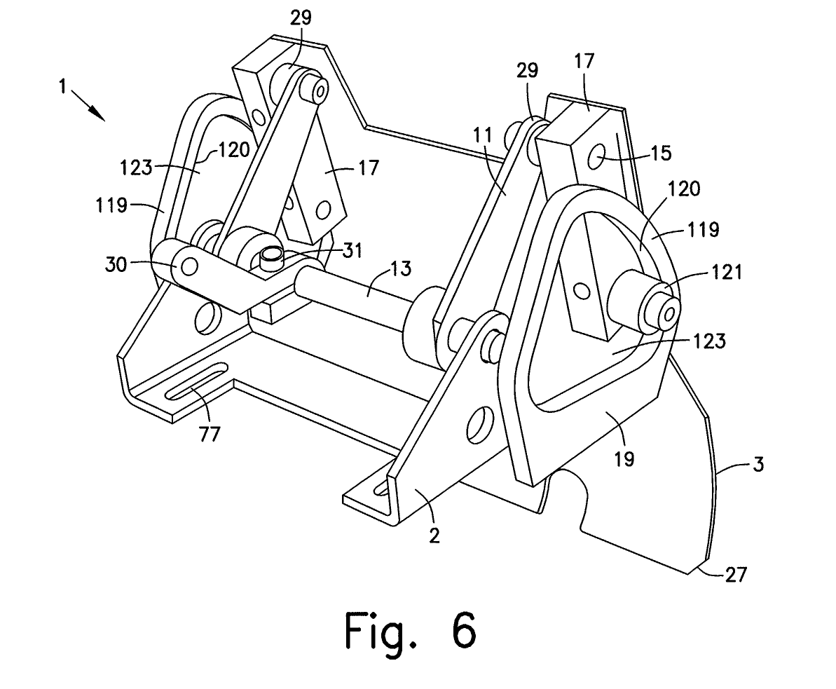

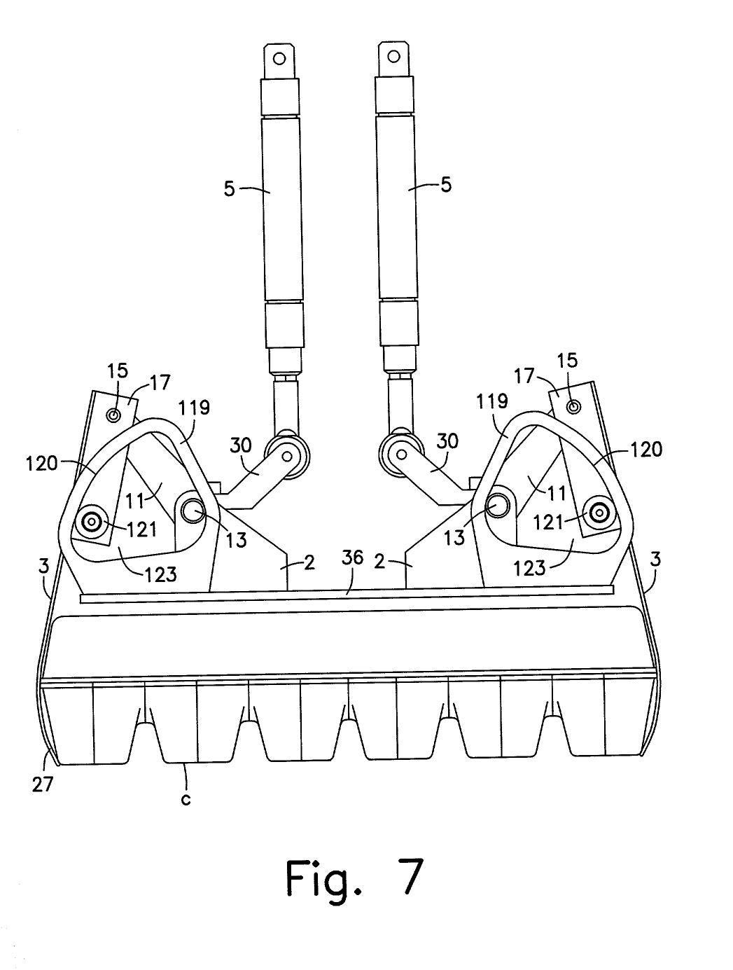

FIGS. 6 to 8 illustrate a third example embodiment of the device 1 according to the present invention. In the third example embodiment of the device 1, the arrangement of the actuation device, i.e., the air cylinders 5, 6, is substantially the same as the arrangement thereof in the second example embodiment of the device 1 as illustrated in FIG. 5. However, the arrangement of the restraining device of the third example embodiment of device 1 is different from the arrangement of the restraining device, i.e., the second link 19, of the first and second example embodiments of the device 1 described above. More particularly, the restraining device of the third example embodiment of device 1 includes a cam 119 having a camming surface 120 and a free space 123. Although the free space 123 is illustrated in FIG. 6 as being an open hole formed in the cam 119, the free space 123 may be formed, for example, as a recess in the surface of the cam 119 to permit the follower 121 to be released from the camming surface 120, as more fully described below. The camming surface 120 constrains the movement of the follower 121 during the opening and closing operation as described above. The restraining device of the third example embodiment of device 1 provides increased maneuverability for the gripping plates 3, 4 in the horizontal and/or vertical directions to thereby provide increased responsiveness for the pickup head 2 to confined spaces. The follower 121 may include a roller or other cam follower element configured to follow the profile of the camming surface 120 to thereby define the path of the gripping plate 3, 4 when the gripping plate 3, 4 is moved between the open position and the closed position. The biasing element 29 of the third example embodiment of the device 1 may be arranged about the pin connection 15 between first link 11 and intermediate position 17, 18 of the gripping element 3, 4. In the third example embodiment of device 1, the biasing element may be in the form of a torsional spring. However, it should be appreciated that the biasing element may also be arranged, for example, as illustrated in FIG. 5. Regardless of the position and arrangement of biasing element 29, it should be understood that biasing element 29 should be configured to urge the gripping plate 3, 4 outwardly so that the follower 121 is urged against the camming surface 120.

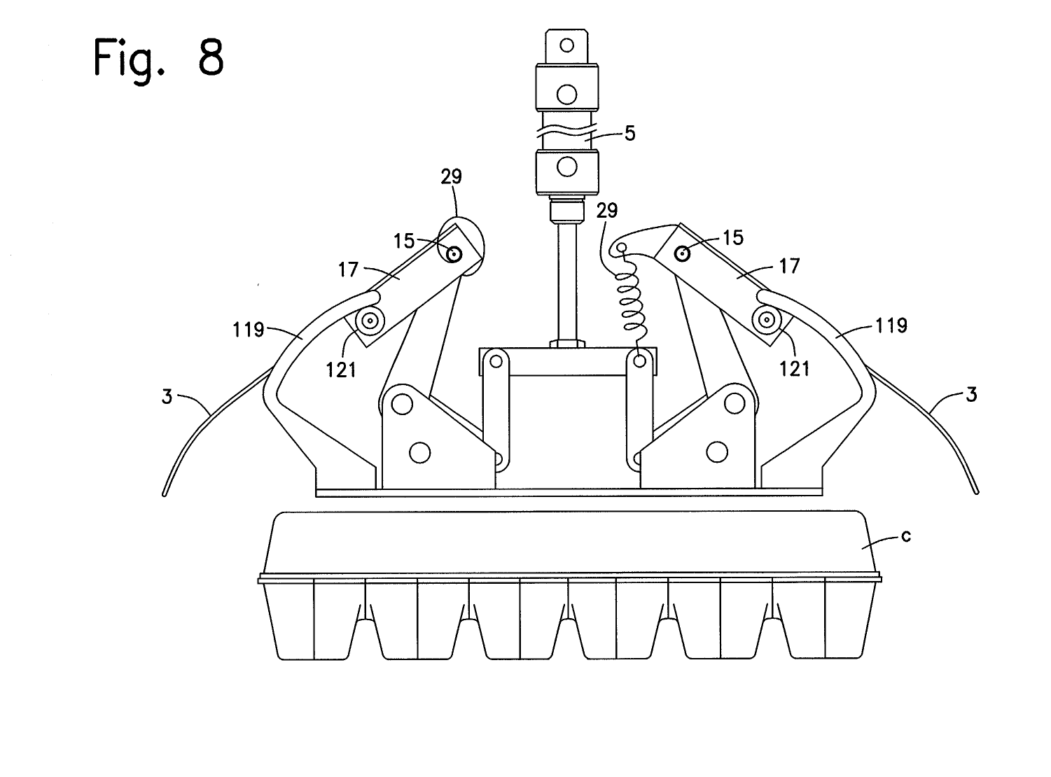

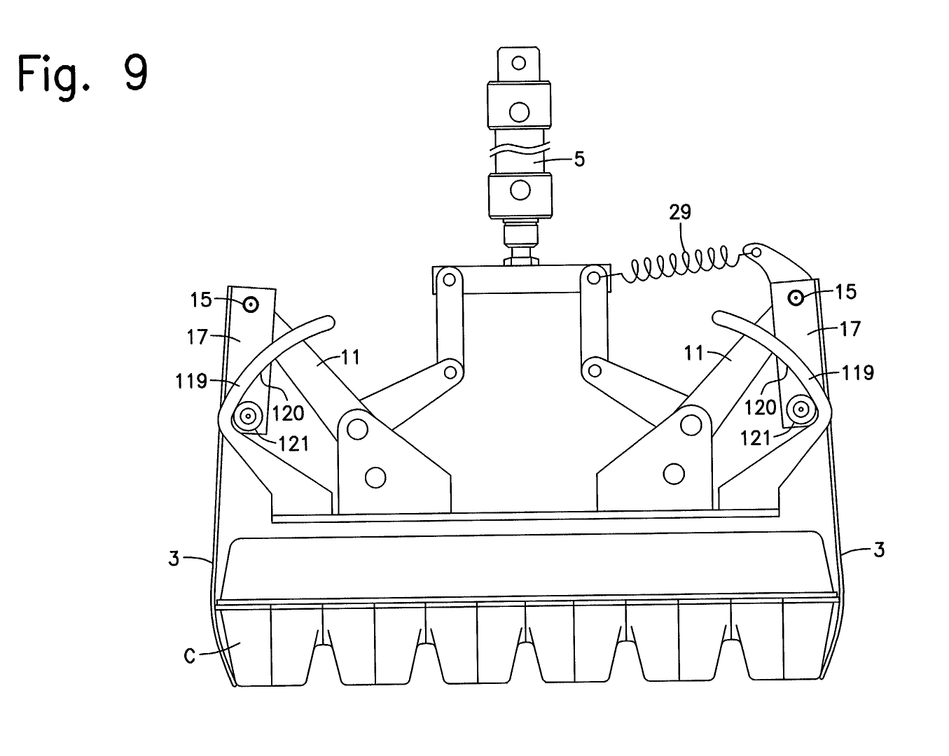

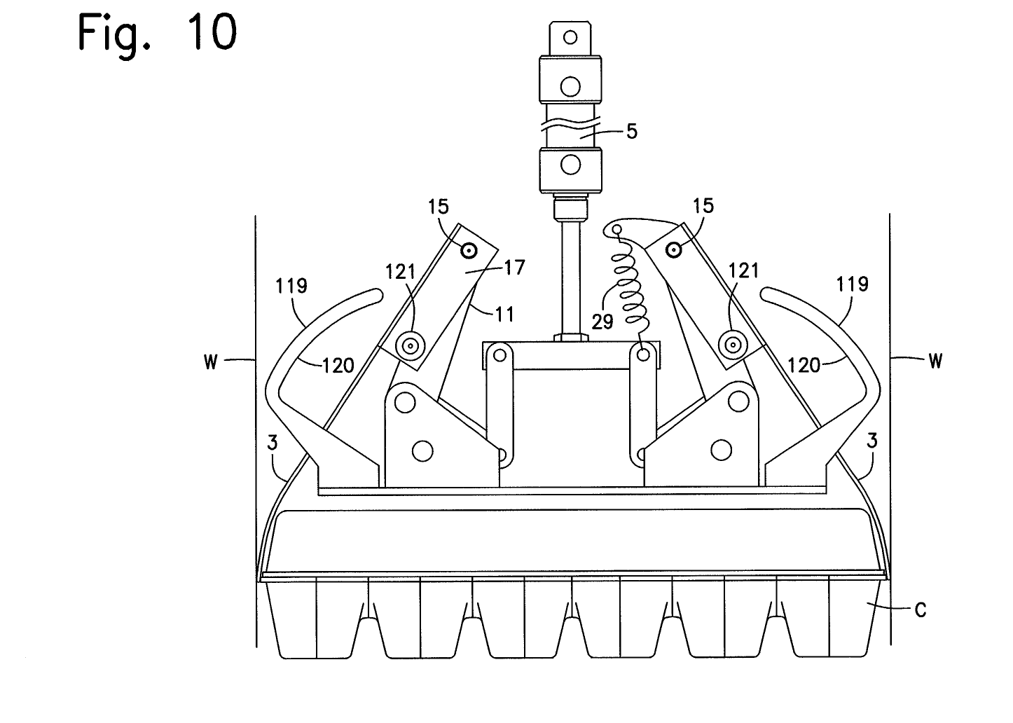

FIGS. 8 to 10 illustrate a fourth example embodiment of the device 1 according to the present invention. The restraining device of the fourth example embodiment of the device 1 is similar to the restraining device of the third example embodiment of the device 1, except that the cam 119 of the fourth example embodiment of the device 1 is in the form of a finger. It should be appreciated that FIG. 8 illustrates the fourth example embodiment of the device 1 in an open position, that FIG. 9 illustrates the fourth example embodiment of the device 1 in a fully closed position and that FIG. 10 illustrates the fourth example embodiment of the device 1 in a partially retracted position. FIG. 8 also illustrates two alternative arrangements of the biasing device 29, i.e., a torsion spring or a helical spring.

It should be understood from the foregoing description of the several example embodiments of the device 1 according to the present invention that the biasing element 29 is arranged to urge the gripping plate 3, 4 outwardly and about the pin connection 15, 16. It should also be appreciated from the foregoing description that the actuation device, i.e., the two air cylinders 5, 6, is configured to rotate the first link 11, 12 about pin connection 13, 14 to thereby translate and rotate the gripping plate 3, 4, as constrained by the links 11, 12 and the restraining device and the interaction of the gripping plate 3, 4 with the interior walls of the container or basket.

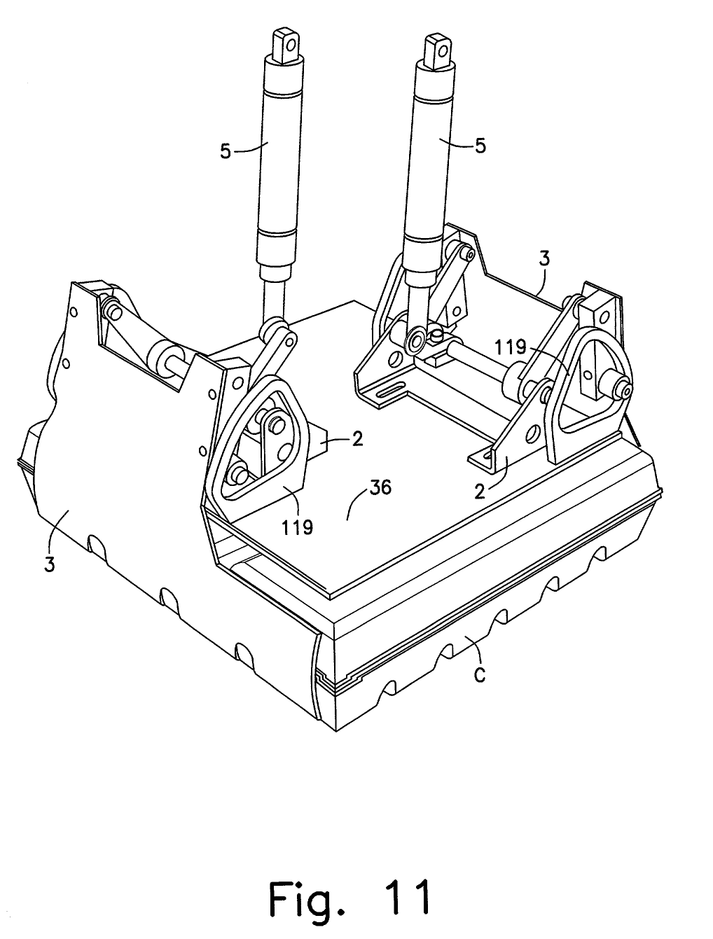

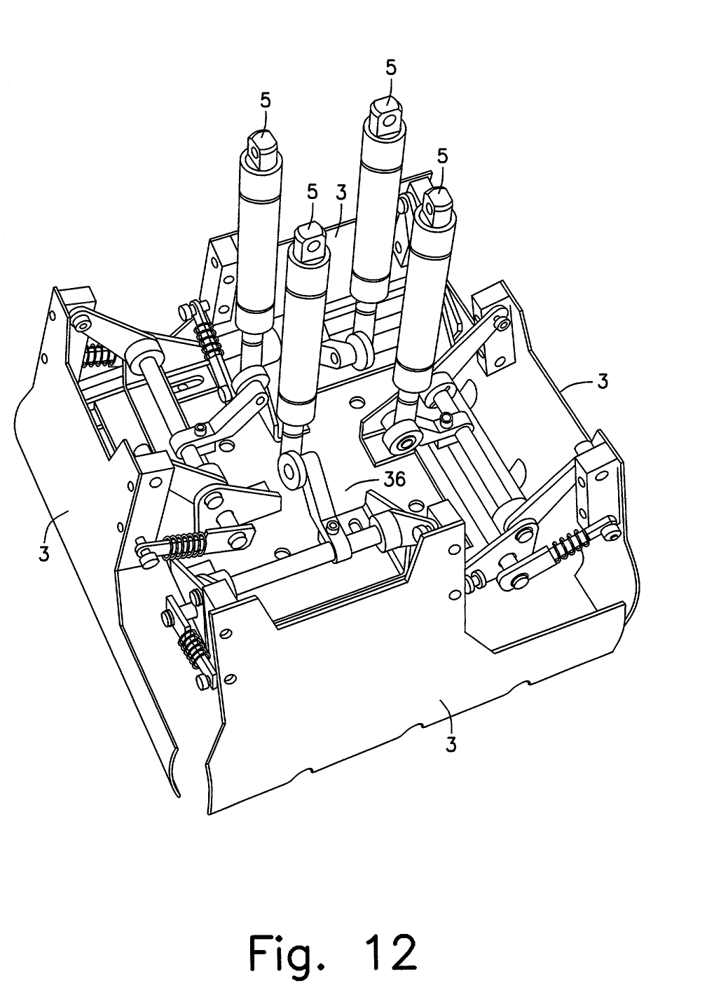

FIG. 11 illustrates the third example embodiment of the device 1 assembled with the base plate 36 and gripping a carton C. As illustrated in FIG. 11, the device 1 may include two gripping plate 3, 4 assemblies. The gripping plates 3, 4 grip the carton C by applying force at two diametrically opposed positions. However, as illustrated in FIG. 12, four gripping plate 3, 4 assembles may be provided and configured to grip the carton C at four locations thereon. While the third example embodiment of device 1 is illustrated in FIG. 11 and the second example embodiment of the device 1 is illustrated in FIG. 12, it should be understood that the device 1 may include any appropriate number of gripping plate 3, 4 assemblies in any combination of arrangements thereof.

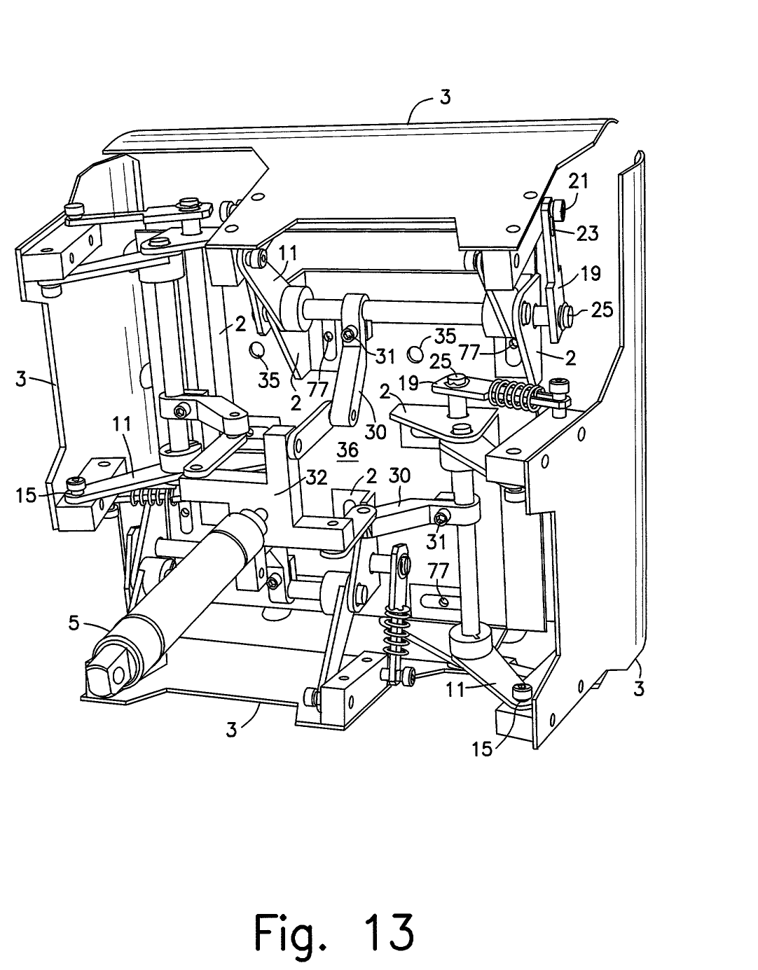

FIG. 13 illustrates a fifth example embodiment of the device 1 according to the present invention that includes four pickup heads 2 positioned to grasp each of the four sides of a container. Furthermore, the connection of the pickup heads 2 to an actuating air cylinder 5 has been modified so that all four of the pickup heads 2 are actuated by a single air cylinder 5.

Specifically, the air cylinder 5 is coupled at an upper end thereof to a frame 33 substantially centrally above the four pickup heads 2 and extends substantially vertically down to couple at its lower end to a spider arm 32. The spider arm 32 is pivotally connected to each of the pickup heads 2 via a two bar linkage consisting of a first bar 39 and an actuating bar 30. Each first bar 39 is rotatably coupled to the spider arm 32 by a pin 39′ and is rotatably coupled to the actuating bar 30 via a pin 30′. Each actuating bar 30 is non-rotatably coupled to a control rod 40. In the fifth example embodiment of the device 1, the non-rotatable coupling is achieved by wrapping a hooked end of each actuating bar 30 around the corresponding control rod 40 and securing the hooked end in place by a bolt 41. Each control rod 40 is non-rotatably coupled to a pair of upper links 42 which are rotatably connected to an upper end of the corresponding gripping plate 3. Each pickup head 2 includes a mounting plate 44 which is rotatably coupled to the control rod 40 and is rotatably coupled to a pair of lower link 46. The mounting plate 44 is rigidly coupled to a base plate 36 by a bolt (not shown) mounted through hole 52. The lower links 46 are then slidably connected to the corresponding gripping plate 3 by pin and slot connections 48. A spring 50 is received around at least one of the lower links 46 corresponding to each gripping plate 3 to bias the gripping plates 3 toward an open position. Of course, those skilled in the art will understand that many known mechanical linkages may be substituted for the described apparatus so long as the resultant motion is duplicated.

The present invention contemplates a number of different variations of the above-described example embodiments. For example, the present invention need not be used for releasing egg cartons or trays within a shipping container as basket but may be used to grip and release any item(s) for which such action is performed within a confined space. In addition, the device according to the present invention may be used to remove items from within a confined space. As should be understood by one of ordinary skill in the art, use of the device according to the present invention to remove items from within a confined space would merely require reversal of the sequence of actuation as described above. The additional step of slightly closing the gripping plates before the insertion thereof into the confined space may be required in the withdrawal operation so that the ends of the gripping plates contact the walls of the confined space and are guided thereby. It should be further understood that the above description is not to be considered limiting and that the scope of the invention is to measured in accordance with the claims as set forth below.

What is claimed is:

1. An apparatus for gripping and releasing at least one item, comprising:
a pickup head;
at least one gripping plate;
a restraining device corresponding to each gripping plate, the restraining device being configured to connect the corresponding gripping plate to the pickup head so that the gripping plate is movable relative to the pickup head between an open position and a closed position and so that the gripping plate is movable relative to the pickup head in at least one degree of freedom at least when the gripping plate is in the open position and in the closed position; and
an actuation device configured to move the at least one gripping plate between the open position and the closed position.

2. The apparatus according to claim 1, wherein the actuation device includes at least one air cylinder.

3. The apparatus according to claim 1, wherein the actuation device includes at least one air cylinder corresponding to each of the at least one gripping plates.

4. The apparatus according to claim 1, wherein the degree of freedom includes a component in a direction toward and away from the at least one item.

5. The apparatus according to claim 1, further comprising at least one biasing element corresponding to each gripping plate, the at least one biasing element urging the corresponding gripping plate in a direction in accordance with the at least one degree of freedom.

6. The apparatus according to claim 5, wherein the at least one biasing device includes at least one spring element.

7. The apparatus according to claim 1, wherein the restraining device includes a linkage system, the linkage system including a first link having a first end rotatably connected to the pickup head and a second end rotatably connected to the corresponding gripping plate.

8. The apparatus according to claim 7, wherein the second end of the first link is rotatably connected to a first end of the corresponding gripping plate.

9. The apparatus according to claim 7, wherein the linkage system includes a second link having a first end connected to the pickup head and a second end having a slot, a portion of the corresponding gripping plate being slidably arranged relative to the slot.

10. The apparatus according to claim 9, wherein the gripping plate includes a pin slidably disposed in the slot.

11. The apparatus according to claim 1, wherein the restraining device includes a camming surface and the gripping plate includes a follower configured to be displaceable in accordance with the camming surface between the open position and the closed position of the corresponding gripping plate.

12. The apparatus according to claim 1, wherein at least one end of the gripping plate is curved.

13. An apparatus for gripping and releasing at least one item, comprising:
a pickup head;
at least one gripping plate;
a restraining device corresponding to each gripping plate, the restraining device being configured to connect the corresponding gripping plate to the pickup head so that the gripping plate is movable relative to the pickup head between an open position and a closed position, an end of the gripping plate being displaced inwardly by the restraining device when the gripping plate moved from the open position to the closed position, the restraining device being further configured to permit the gripping plate to be movable relative to the pickup head in at least one degree of freedom at least when the gripping plate is being moved from the closed position to the open position; and
an actuation device configured to move the at least one gripping plate between the open position and the closed position.

14. The apparatus according to claim 13, further comprising at least one biasing element corresponding to each gripping plate, the at least one biasing element urging the corresponding gripping plate in a direction in accordance with the at least one degree of freedom.

15. The apparatus according to claim 14, wherein the at least one biasing device includes at least one spring element.

16. The apparatus according to claim 13, wherein the actuation device includes at least one air cylinder.

17. The apparatus according to claim 13, wherein the actuation device includes at least one air cylinder corresponding to each of the at least one gripping plates.

18. The apparatus according to claim 13, wherein the degree of freedom includes a component in a direction toward and away from the at least one item.

19. The apparatus according to claim 13, wherein the restraining device includes a linkage system, the linkage system including a first link having a first end rotatably connected to the pickup head and a second end rotatably connected to the corresponding gripping plate.

20. The apparatus according to claim 19, wherein the second end of the first link is rotatably connected to a first end of the corresponding gripping plate.

21. The apparatus according to claim 19, wherein the linkage system includes a second link having a first end connected to the pickup head and a second end having a slot, a portion of the corresponding gripping plate being slidably arranged relative to the slot.

22. The apparatus according to claim 21, wherein the gripping plate includes a pin slidably disposed in the slot.

23. The apparatus according to claim 13, wherein the restraining device includes a camming surface and the gripping plate includes a follower configured to be displaceable in accordance with the camming surface between the open position and the closed position of the corresponding gripping plate.

24. The apparatus according to claim 13, wherein at least one end of the gripping plate is curved.
